(19) United States
(12) Patent Application Publication
(10) Pub. No.: US 2024/0119525 A1
(43) Pub. Date: Apr. 11, 2024

(54) INFORMATION PROVIDING SERVER, DATA PROCESSING APPARATUS, INFORMATION PROVIDING METHOD, AND NON-TRANSITORY STORAGE MEDIUM

(71) Applicant: NEC Corporation, Minato-ku, Tokyo (JP)

(72) Inventor: Toshihiko Fujii, Tokyo (JP)

(73) Assignee: NEC Corporation, Minato-ku, Tokyo (JP)

(21) Appl. No.: 18/275,952

(22) PCT Filed: Nov. 9, 2021
(86) PCT No.: PCT/JP2021/041072

§ 371 Date: Aug. 4, 2023

(30) Foreign Application Priority Data
Feb. 19, 2021 (JP) 2021-024931

(51) Int. Cl. G06Q 40/04; G06Q 40/06

(52) U.S. Cl. CPC G06Q 40/04; G06Q 40/06

(57) ABSTRACT

An information providing server according to the present invention outputs a screen on which referenced customer buy/sell pattern time-series data (4-2) indicating, in a time-series manner, a buy/sell pattern, computed for each stock, of a plurality of referenced customers satisfying a reference standard, based on past investment product transaction data of the plurality of referenced customers, and a price chart (4-1) indicating a time-series change in price of an investment product are displayed side by side.

### TECHNICAL FIELD

The present invention relates to an information providing server, a data processing apparatus, an information providing method, and a program.

### BACKGROUND ART

A technique relating to the present invention is disclosed in Patent Documents 1 to 4. Patent Document 1 discloses a technique in which a transaction style is defined by clustering a transaction trend of a user, based on pieces of past transaction information of all users and market information, and an advice is given by searching for a route to a target transaction style.

Patent Document 2 discloses a technique in which an advice for a customer who buys and sells an investment product such as a stock, an investment trust, an exchange traded fund (ETF), and foreign exchange margin trading (FX) is generated and presented. In the technique, a diagnosis result including information relating to a buy/sell pattern of a user, information relating to a reason for a buy/sell pattern of a user, information relating to a social aspect relating to a buy/sell pattern of a user, and information for improving a buy/sell pattern of a user is generated, and an advice according to the diagnosis result is generated.

Patent Document 3 discloses a technique in which a step of summarizing pieces of investment data and real time trade data of a plurality of investors, a step of ranking the plurality of investors according to an investment performance to be derived from the investment data, a step of generating stock ranking of stocks held by the plurality of investors by using the ranking and the trade data, and a step of providing a customized recommendation are executed.

Patent Document 4 discloses a learning means of a determination list being one of rule-based models in which a plurality of simple conditions are combined.

### RELATED DOCUMENT

### Patent Document

Patent Document 1: International Publication No. WO2019/087552
Patent Document 2: Japanese Patent Application Publication No. 2019-74863
Patent Document 3: Japanese Patent Application Publication (Translation of PCT Application) No. 2010-501909
Patent Document 4: International Publication No. WO2020/059136

### DISCLOSURE OF THE INVENTION

### Technical Problem

In transaction of an investment product, it is difficult to determine a buying and selling timing. It is also not easy to review whether transaction of the investment product is good or bad.

A problem of the present invention is to provide a retrospective means and opportunity relating to transaction of an investment product.

### Solution to Problem

The present invention provides an information providing server including an output unit that outputs a screen on which referenced customer buy/sell pattern time-series data indicating, in a time-series manner, a buy/sell pattern, computed for each stock, of a plurality of referenced customers satisfying a reference standard, based on past investment product transaction data of the plurality of referenced customers, and a price chart indicating a time-series change in price of an investment product are displayed side by side.

Further, the present invention provides an information providing method including,
by a computer,
outputting a screen on which referenced customer buy/sell pattern time-series data indicating, in a time-series manner, a buy/sell pattern, computed for each stock, of a plurality of referenced customers satisfying a reference standard, based on past investment product transaction data of the plurality of referenced customers, and a price chart indicating a time-series change in price of an investment product are displayed side by side.

Further, the present invention provides a program causing a computer to function as
an output unit that outputs a screen on which referenced customer buy/sell pattern time-series data indicating, in a time-series manner, a buy/sell pattern, computed for each stock, of a plurality of referenced customers satisfying a reference standard, based on past investment product transaction data of the plurality of referenced customers, and a price chart indicating a time-series change in price of an investment product are displayed side by side.

Further, the present invention provides a data processing apparatus including:
a determination unit that determines a plurality of referenced customers satisfying a reference standard, from among a plurality of customers; and
a computation unit that computes referenced customer buy/sell pattern time-series data indicating, in a time-series manner, a buy/sell pattern of the plurality of referenced customers for each stock, based on past investment product transaction data of the plurality of referenced customers.

### Advantageous Effects of Invention

The present invention achieves a technique for being capable of acquiring a retrospective means and opportunity relating to transaction of an investment product.

### BRIEF DESCRIPTION OF THE DRAWINGS

FIG. 1 It is a diagram illustrating one example of a screen to be provided by an information providing server according to a present example embodiment.

FIG. 2 It is a diagram illustrating one example of a hardware configuration of the information providing server and a data processing apparatus according to the present example embodiment.

FIG. 3 It is one example of a functional block diagram of the data processing apparatus according to the present example embodiment.

FIG. 4 It is a diagram illustrating a concept of an arithmetic operation of the data processing apparatus according to the present example embodiment.

FIG. 5 It is a diagram illustrating a concept of an arithmetic operation of the data processing apparatus according to the present example embodiment.

FIG. 6 It is one example of a functional block diagram of the information providing server according to the present example embodiment.

### DESCRIPTION OF EMBODIMENTS

Hereinafter, an example embodiment according to the present invention is described with reference to the drawings. Note that, in all drawings, a similar constituent element is indicated by a similar reference sign, and description thereof is omitted as necessary.

### <Overview>

First, an overview of a technique according to a present example embodiment is described. The technique according to the present example embodiment is a technique capable of acquiring a retrospective means and opportunity relating to transaction of an investment product such as a stock. The technique according to the present example embodiment is utilized, for example, in a business entity (such as a securities company) that acts as an agency or the like of buying and selling an investment product. The business entity provides a customer with information capable of acquiring a retrospective means and opportunity relating to transaction of an investment product by utilizing the technique according to the present example embodiment. For example, the information is provided to the customer via a Web page or an application of a business entity. Note that, the usage example is merely one example, and the present example embodiment is not limited thereto.

The technique according to the present example embodiment is achieved by a data processing apparatus that generates data to be provided to a customer, and an information providing server that transmits predetermined information to a customer terminal according to a customer request.

The data processing apparatus determines, as a referenced customer, a customer (e.g., a customer who is making a profit, or the like) whose buying and selling timing is helpful. Then, the data processing apparatus generates data indicating, in a time-series manner, a buy/sell pattern of the referenced customer, based on past investment product transaction data of the determined referenced customer. Further, the information providing server provides a customer with a screen on which the generated data indicating, in a time-series manner, a buy/sell pattern of the referenced customer, and data indicating a time-series change in price of an investment product are displayed side by side.

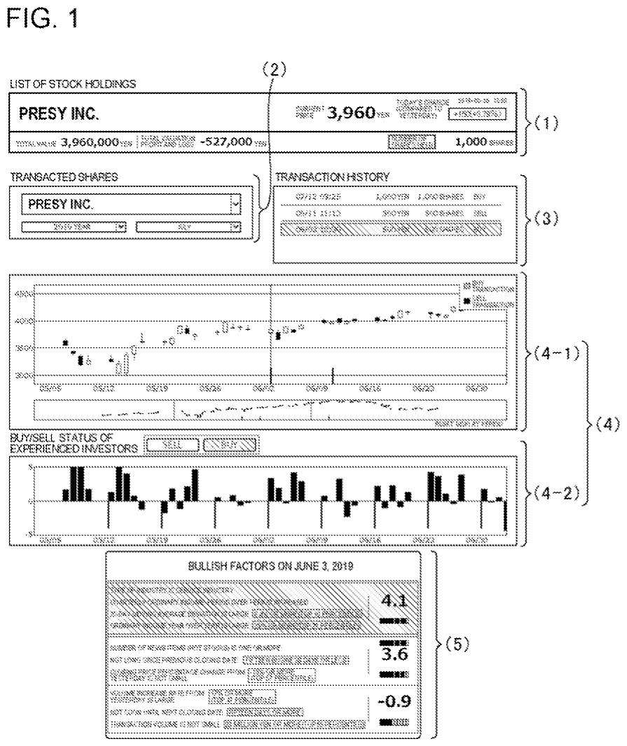

(4) in FIG. 1 illustrates one example of the information. While details are described in the following, (4-1) in FIG. 1 is data illustrating a time-series change in price of an investment product, and (4-2) in FIG. 1 is data indicating, in a time-series manner, a buy/sell pattern of a referenced customer. In (4-2) in FIG. 1, a buying pattern of a referenced customer is indicated in a time-series manner. It means that the larger the value, the stronger the buying pattern, and the smaller the value, the weaker the buying pattern. Note that, it is possible to switch between a graph indicating a buying pattern of a referenced customer, and a graph indicating a selling pattern of the referenced customer by a screen operation. A selling pattern of the referenced customer is indicated by a method similar to that of the buying pattern. The screen allows a customer to confirm a relationship between a change in price of an investment product, and a buy/sell pattern of a referenced customer.

Further, the data processing apparatus presumes a cause of a buy/sell pattern of a referenced customer at each timing, based on past investment product transaction data of a determined referenced customer, and a past state value of each of a plurality of determination material items (which may affect determination on buying and selling of an investment product, and, for example, such as the number of days from a previous closing date). Further, the information providing server provides the customer with a screen indicating the presumption result, specifically, a cause of a buy/sell pattern of a referenced customer at each timing.

(5) in FIG. 1 illustrates one example of the information. While details are described in the following, (5) in FIG. 1 indicates a determination material item being presumed to be a cause of a buying pattern of a referenced customer on Jun. 3, 2019, and a state value thereof. The screen allows a customer to confirm based on what determination material, a referenced customer has determined a buying and selling timing, and the like.

### “Configuration of Data Processing Apparatus”

Next, a configuration of the data processing apparatus is described. As described above, the data processing apparatus is an apparatus that generates data to be provided to a customer.

### <Hardware Configuration>

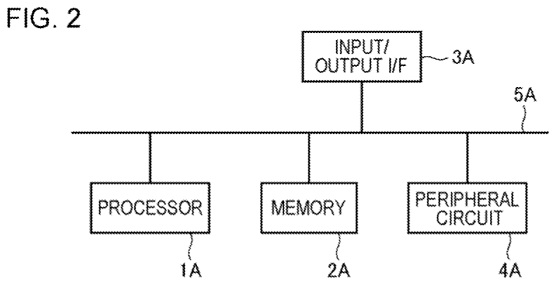

One example of a hardware configuration of the data processing apparatus is described. FIG. 2 is a diagram illustrating a hardware configuration example of the data processing apparatus. Each functional unit included by the data processing apparatus is achieved by any combination of hardware and software mainly including a central processing unit (CPU) of any computer, a memory, a program loaded in a memory, a storage unit (capable of storing, in addition to a program stored in advance at a shipping stage of an apparatus, a program downloaded from a storage medium such as a compact disc (CD), a server on the Internet, and the like) such as a hard disk storing the program, and an interface for network connection. Further, it is understood by a person skilled in the art that there are various modification examples as a method and an apparatus for achieving the configuration.

As illustrated in FIG. 2, the data processing apparatus includes a processor 1A, a memory 2A, an input/output interface 3A, a peripheral circuit 4A, and a bus 5A. The peripheral circuit 4A includes various modules. The data processing apparatus may not include the peripheral circuit 4A. Note that, the data processing apparatus may be constituted of a plurality of apparatuses that are physically and/or logically separated, or may be constituted of one apparatus that is physically and logically integrated. In the former case, each of the plurality of apparatuses constituting the data processing apparatus can include the above-described hardware configuration.

The bus 5A is a data transmission path along which the processor 1A, the memory 2A, the peripheral circuit 4A, and the input/output interface 3A mutually transmit and receive data. The processor 1A is, for example, an arithmetic processing apparatus such as a CPU and a graphics processing unit (GPU). The memory 2A is, for example, a memory such as a random access memory (RAM) and a read only memory (ROM). The input/output interface 3A includes an interface for acquiring information from an input apparatus, an external apparatus, an external server, an external sensor, and the like, an interface for outputting information to an output apparatus, an external apparatus, an external server, and the like, and the like. The input apparatus is, for example, a keyboard, a mouse, a microphone, and the like. The output apparatus is, for example, a display, a speaker, a printer, a mailer, and the like. The processor 1A can issue a command to each module, and perform an arithmetic operation, based on these arithmetic operation results.

### <Functional Configuration>

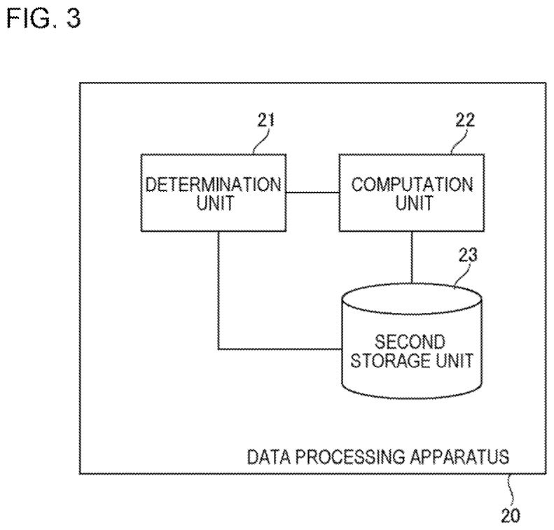

Next, a functional configuration of the data processing apparatus is described. FIG. 3 illustrates one example of a functional block diagram of a data processing apparatus 20. As illustrated in FIG. 3, the data processing apparatus 20 includes a determination unit 21, a computation unit 22, and a second storage unit 23.

The determination unit 21 determines a plurality of referenced customers satisfying a reference standard from among a plurality of customers. The determination result is utilized by processing by the computation unit 22 to be described in the following.

A “customer” is a customer of a business entity utilizing the technique according to the present example embodiment.

A “business entity utilizing the technique according to the present example embodiment” is, for example, a business entity which acts as an agency or the like of buying and selling an investment product.

As an “investment product”, a stock, an investment trust, an exchange traded fund (ETF), foreign exchange margin trading (FX), gold, a virtual currency, a bond, a real estate investment trust (REIT), and the like are exemplified, but the present example embodiment is not limited thereto.

A “reference standard” is set in such a way as to satisfy a customer whose buying and selling timing is helpful, and not to satisfy a customer whose buying and selling timing is not helpful.

For example, the reference standard is defined by using a valuation profit and loss within a reference period. As one example of a standard utilizing a valuation profit and loss within a reference period, an example in which “a valuation profit and loss within a reference period belongs to top M % among all customers”, and the like are exemplified. According to a reference standard as described above, a customer who is making a particularly excellent profit among all customers is determined as a referenced customer.

Note that, the reference standard may be defined by further using, in addition to a valuation profit and loss within a reference period, at least one of a number of buy/sell per day within a reference period, a total number of buy/sell within a reference period, and a number of stocks buying and selling within a reference period.

As one example of a standard utilizing a number of buy/sell per day within a reference period, an example in which “a statistical value (such as a maximum value, an average value, or a mode) of a number of buy/sell per day within a reference period is equal to or less than a first reference value”, and the like are exemplified. According to a reference standard as described above, it is possible to exclude, from referenced customers, a day trader who frequently repeats buying and selling.

As one example of a standard utilizing a total number of buy/sell within a reference period, an example in which “a total number of buy/sell within a reference period is equal to or more than a second reference value”, and the like are exemplified. According to a reference standard as described above, it is possible to exclude, from referenced customers, a customer whose buy/sell frequency is extremely small.

As one example of a standard utilizing a number of stocks buying and selling within a reference period, an example in which “a number of stocks buying and selling within a reference period is equal to or more than a third reference value”, and the like are exemplified. According to a reference standard as described above, it is possible to exclude, from referenced customers, a customer whose buy/sell frequency is extremely small.

For example, the reference standard may be made in which “a standard utilizing a valuation profit and loss within a reference period”, and “at least one of a standard utilizing a number of buy/sell per day within a reference period, a standard utilizing a total number of buy/sell within a reference period, and a standard utilizing a number of stocks buying and selling within a reference period” are connected to each other by a logical operator (e.g., “logical AND”).

A “reference period” is a period to be referred to for determining a referenced customer. There are a variety of determining methods of the reference period. For example, the reference period may be a most recent predetermined period (example: most recent one year, most recent sixth months, and the like). In a case where the reference period is determined as described above, the reference period is updated every day. Consequently, a customer to be determined as a referenced customer may also change every day. Note that, the reference period may be defined by another method such as a previous month, a previous year, or a previous fiscal year.

Further, the reference period may be a fixed value being determined in advance, or may be freely set by a customer. In the latter case, a customer can specify a desired period, and learn a buying and selling timing from a referenced customer who is making an excellent profit in the period. For example, setting the reference period long enables to set, as a referenced customer, a customer who is making an excellent profit continuously for a long period. Further, for example, setting, as a reference period, a period during which a price of an investment product is falling enables to set, as a referenced customer, a customer who is making an excellent result during a period as described above.

The second storage unit 23 stores past investment product transaction data (such as a buy/sell history, profit and loss, and earnings) of each of a plurality of customers. The determination unit 21 determines a plurality of referenced customers satisfying the reference standard, based on the investment product transaction data stored in the second storage unit 23.

Note that, the determination unit 21 may further determine a plurality of comparative customers satisfying a comparative standard from among a plurality of customers. The determination result is utilized by processing by the computation unit 22 to be described in the following.

A “comparative standard” is set in such a way as to satisfy a customer whose buying and selling timing is not helpful, and not to satisfy a customer whose buying and selling timing is helpful.

For example, the comparative standard is defined by using a valuation profit and loss within a reference period. As one example of a standard utilizing a valuation profit and loss within a reference period, an example in which “a valuation profit and loss within a reference period belongs to bottom N % among all customers”, and the like are exemplified. According to a comparative standard as described above, a customer who is not making a profit among all customers is determined as a comparative customer.

Note that, similarly to the reference standard, the comparative standard may be defined by further using, in addition to a valuation profit and loss within a reference period, at least one of a number of buy/sell per day within a reference period, a total number of buy/sell within a reference period, and a number of stocks buying and selling within a reference period. Details thereof are similar to those of the reference standard. Defining the comparative standard by using items as described above enables to exclude, from comparative customers, a day trader who frequently repeats buying and selling, and a customer whose buy/sell frequency is extremely small.

The second storage unit 23 stores past investment product transaction data (such as a buy/sell history, profit and loss, and earnings) of each of a plurality of customers. The determination unit 21 determines a plurality of comparative customers satisfying the comparative standard, based on the investment product transaction data stored in the second storage unit 23.

The computation unit 22 executes processing of computing referenced customer buy/sell pattern time-series data, and processing of presuming a cause of a buy/sell pattern indicated by the referenced customer buy/sell pattern time-series data at each timing. Hereinafter, each piece of the processing is described in detail.

### —Processing of Computing Referenced Customer Buy/Sell Pattern Time-Series Data—

The computation unit 22 computes, based on past investment product transaction data of a plurality of referenced customers determined by the determination unit 21, referenced customer buy/sell pattern time-series data for each stock.

The “referenced customer buy/sell pattern time-series data” are data indicating, in a time-series manner, a buy/sell pattern of a plurality of referenced customers. Data in (4-2) in FIG. 1 are referenced customer buy/sell pattern time-series data.

The computation unit 22 separately generates referenced customer buy/sell pattern time-series data indicating, in a time-series manner, a buying pattern of a plurality of referenced customers, and referenced customer buy/sell pattern time-series data indicating, in a time-series manner, a selling pattern of the plurality of referenced customers. There is a case that a buying pattern and a selling pattern are simultaneously strengthened or weakened. Therefore, data indicating a buying pattern and data indicating a selling pattern are separately generated.

The referenced customer buy/sell pattern time-series data indicating, in a time-series manner, a buying pattern of the plurality of referenced customers are data indicating strength of a buying pattern by a numerical value for each predetermined unit period. The computation unit 22 computes a numerical value indicating strength of a buying pattern for each unit period, based on a predetermined arithmetic expression. In (4-2) in FIG. 1, the unit period is “one day”, and strength of a buying pattern is illustrated by “a value in a range from a maximum value +5 to a minimum value −5”. It is illustrated that the larger the value, the stronger the buying pattern. Note that, this example is merely one example, and the present example embodiment is not limited thereto.

Further, the referenced customer buy/sell pattern time-series data indicating, in a time-series manner, a selling pattern of the plurality of referenced customers are data indicating strength of a selling pattern by a numerical value for each predetermined unit period. The computation unit 22 computes a numerical value indicating strength of a selling pattern for each unit period, based on a predetermined arithmetic expression. Similarly to the example in (4-2) in FIG. 1, for example, the unit period is “one day”, and strength of a selling pattern is illustrated by “a value in a range from a maximum value +5 to a minimum value −5”. It is illustrated that the larger the value, the stronger the selling pattern. Note that, this example is merely one example, and the present example embodiment is not limited thereto.

There are various methods of computing strength of a buying pattern and strength of a selling pattern, and various methods can be adopted in the present example embodiment. Hereinafter, one example is described.

### Computation Example 1

In the example, strength of a buying pattern for each unit period is computed based on “to what extent, a referenced customer buys more or less, as compared with a predetermined period”, specifically, based on a comparison result with respect to a buying pattern in the predetermined period.

As a degree by which buying is increased increases, as compared with the predetermined period, the numerical value indicating strength of a buying pattern is increased. Further, as a degree by which buying is decreased increases, as compared with the predetermined period, the numerical value indicating strength of a buying pattern is decreased.

The predetermined period may be most recent several days, may be most recent several months, may be most recent one year, or may be other than the above.

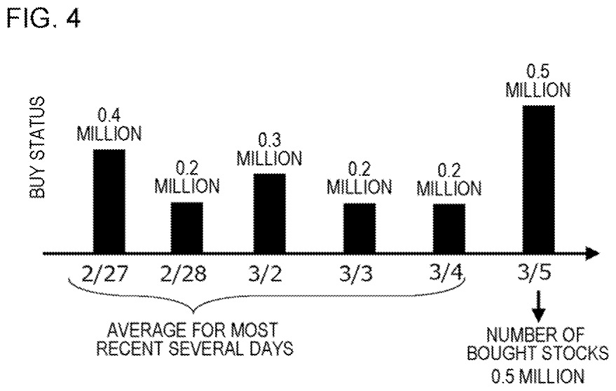

The above is described in more detail by using FIG. 4. FIG. 4 is a diagram illustrating a concept of processing of computing strength of a buying pattern on March 5. Five days from February 27 to March 4 in FIG. 4 corresponds to the predetermined period. A bar graph and a numerical value (the number of purchased shares) displayed above the bar graph illustrate buy status of a referenced customer of each day. The number of purchased shares indicating buy status of the referenced customer is a statistical value (such as a total value or an average value) of the number of purchased shares of each of a plurality of referenced customers. Note that, a method of indicating buy status by the number of purchased shares is one example of a case where an investment target is a stock. The buy status of the referenced customer can be expressed by a numerical value by an appropriate method according to a type of an investment target.

In a case of the example in FIG. 4, the buy status on March 5 is larger than the buy status in the predetermined period (an average value in the predetermined period). Therefore, a numerical value indicating strength of a buying pattern on March 5 becomes a plus value. Further, as a deviation between the buy status on March 5, and the buy status in the predetermined period (an average value in the predetermined period) increases, a numerical value indicating strength of a buying pattern on March 5 becomes a larger value.

Note that, although not illustrated, in a case where the buy status on March 5 is smaller than the buy status in the predetermined period (an average value in the predetermined period), a numerical value indicating strength of a buying pattern on March 5 becomes a minus value. Further, as a deviation between the buy status on March 5, and the buy status in the predetermined period (an average value in the predetermined period) increases, a numerical value indicating strength of a buying pattern on March 5 becomes a smaller value.

### Computation Example 2

In the example, strength of a buying pattern of a referenced customer for each unit period is computed based on “to what extent, a referenced customer buys more or less, as compared with the predetermined period”, and “to what extent, a comparative customer buys more or less, as compared with the predetermined period”.

As a degree by which the referenced customer buys more is increased, as compared with the predetermined period, a numerical value indicating strength of a buying pattern of the referenced customer is increased. In this case, as a degree by which the comparative customer buys more is decreased, as compared with the predetermined period, a numerical value indicating strength of a buying pattern of the referenced customer is increased.

Further, as a degree by which the referenced customer buys less is increased, as compared with the predetermined period, a numerical value indicating strength of a buying pattern of the referenced customer is decreased. In this case, as a degree by which the comparative customer buys less is decreased, as compared with the predetermined period, a numerical value indicating strength of a buying pattern of the referenced customer is decreased.

The predetermined period may be most recent several days, may be most recent several months, may be most recent one year, or may be other than the above.

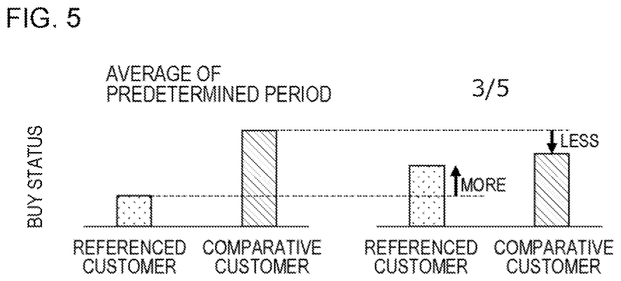

The above is described in more detail by using FIG. 5. FIG. 5 is a diagram illustrating a concept of processing of computing strength of a buying pattern of a referenced customer on March 5. A bar graph illustrates buy status of each of a referenced customer and a comparative customer on March 5, and buy status in the predetermined period (an average value in the predetermined period). The buy status of the referenced customer is a statistical value (such as a total value or an average value) of the number of purchased shares of each of a plurality of referenced customers. Likewise, the buy status of the comparative customer is a statistical value (such as a total value or an average value) of the number of purchased shares of each of a plurality of comparative customers. Note that, a method of indicating buy status by the number of purchased shares is one example of a case where an investment target is a stock. The buy status of the referenced customer can be expressed by a numerical value by an appropriate method according to a type of an investment target.

In a case of the example in FIG. 5, the buy status of the referenced customer on March 5 is larger than the buy status of the referenced customer in the predetermined period (an average value in the predetermined period). Therefore, a numerical value indicating strength of a buying pattern of the referenced customer on March 5 becomes a plus value. Further, as a deviation between the buy status of the referenced customer on March 5, and the buy status of the referenced customer in the predetermined period (an average value in the predetermined period) increases, a numerical value indicating strength of a buying pattern of the referenced customer on March 5 becomes a larger value. Further, as the buy status of the comparative customer on March 5 becomes smaller than the buy status of the comparative customer in the predetermined period (an average value in the predetermined period), a numerical value indicating strength of a buying pattern of the referenced customer on March 5 becomes a larger value.

Note that, although not illustrated, in a case where the buy status of the referenced customer on March 5 is smaller than the buy status of the referenced customer in the predetermined period (an average value in the predetermined period), a numerical value indicating strength of a buying pattern of the referenced customer on March 5 becomes a minus value. Further, as a deviation between the buy status of the referenced customer on March 5, and the buy status of the referenced customer in the predetermined period (an average value in the predetermined period) increases, a numerical value indicating strength of a buying pattern on March 5 becomes a smaller value. Further, as the buy status of the comparative customer on March 5 becomes larger than the buy status of the comparative customer in the predetermined period (an average value in the predetermined period), a numerical value indicating strength of a buying pattern of the referenced customer on March 5 becomes a smaller value.

In this way, also utilizing data of a comparative customer enables to emphasize a numerical value at a timing to be particularly paid attention to among a buy/sell pattern of a referenced customer, specifically, a timing indicating a pattern different from that of the comparative customer.

### Computation Example 3

In the example, strength of a selling pattern for each unit period is computed based on “to what degree, a referenced customer sells more or less, as compared with the predetermined period”, specifically, based on a comparison result with respect to a selling pattern in the predetermined period.

As a degree by which selling is increased increases, as compared with the predetermined period, a numerical value indicating strength of a selling pattern is increased. Further, as a degree by which selling is decreased increases, as compared with the predetermined period, a numerical value indicating strength of a selling pattern is decreased.

The predetermined period may be most recent several days, may be most recent several months, may be most recent one year, or may be other than the above. Details are similar to those in the computation example 1.

### Computation Example 4

In the example, strength of a selling pattern of a referenced customer is computed based on “to what degree, a referenced customer sells more or less, as compared with the predetermined period”, and “to what extent, a comparative customer sells more or less, as compared with the predetermined period”.

As a degree by which the referenced customer sells more is increased, as compared with the predetermined period, a numerical value indicating strength of a selling pattern of the referenced customer is increased. In this case, as a degree by which the comparative customer sells more is decreased, as compared with the predetermined period, a numerical value indicating strength of a selling pattern of the referenced customer is increased.

Further, as a degree by which the referenced customer sells less is increased, as compared with the predetermined period, a numerical value indicating strength of a selling pattern of the referenced customer is decreased. In this case, as a degree by which the comparative customer sells less is decreased, as compared with the predetermined period, a numerical value indicating strength of a selling pattern of the referenced customer is decreased.

The predetermined period may be most recent several days, may be most recent several months, may be most recent one year, or may be other than the above. Details are similar to those in the computation example 2.

In this way, also utilizing data of a comparative customer enables to emphasize a numerical value at a timing to be particularly paid attention to among a buy/sell pattern of a referenced customer, specifically, a timing indicating a pattern different from that of the comparative customer.

### —Processing of Presuming Cause of Buy/Sell Pattern Indicated by Referenced Customer Buy/Sell Pattern Time-Series Data at Each Timing—

The computation unit 22 presumes a cause of a buy/sell pattern indicated by referenced customer buy/sell pattern time-series data at each timing, based on past investment product transaction data of a plurality of referenced customers determined by the determination unit 21, and a past state value of each of a plurality of determination material items.

The determination material item may affect determination on buying and selling of an investment product. The determination material item is different for each investment product. The determination material item in a case where an investment product is a stock is, for example, a moving average deviation (5 days), a moving average deviation (25 days), a moving average deviation (75 days), a golden cross (a moving average line between a 5-day moving average deviation and a 25-day moving average deviation), a dead cross (a moving average line between a 5-day moving average deviation and a 25-day moving average deviation), and the like to be acquired from a stock price chart. In addition, the determination material items in a case where an investment product is a stock are various pieces of information relating to a company, and the number of years from establishment, a market, the number of days since listed, a type of industry, a full-year amount of sales, a full-year operating income, a full-year ordinary income, a full-year final profit, a full-year amount of sales year over year, a full-year operating income year over year, a full-year ordinary income year over year, a full-year final profit year over year, the number of news items, the number of weekly news items, the number of timely disclosures, the number of weekly timely disclosures, an expected price earnings ratio (PER), expected earnings per share (EPS), expected return on equity (ROE), an expected dividend yield, an actual dividend yield, an actual dividend payout ratio, an actual price book value ratio (PBR), an actual book value per share (BPS), and the like are exemplified. Note that, the example herein is merely one example, and the present example embodiment is not limited thereto.

Herein, processing of presuming a cause of a buy/sell pattern at each timing is described. The computation unit 22 presumes a cause of a buy/sell pattern at each timing by utilizing a model in which the above-described “referenced customer buy/sell pattern time-series data” are regressed from these “past state values of a determination material item”. As illustrated in (4-2) in FIG. 1, in a case where a numerical value indicating strength of a buying pattern and a selling pattern of a referenced customer is computed on a daily basis, the computation unit 22 presumes a cause that has led to strength of a buying pattern, and a cause that has led to strength of a selling pattern of each day on a daily basis.

The model is achieved by utilizing a learning means disclosed in Patent Document 4. The model is generated by learning in which past investment product transaction data (objective variable) of a plurality of referenced customers, and a past state value (explanatory variable) of each of a plurality of determination material items are used as training data. According to the model, it is possible to determine in advance a rule that well contributes to regression of the above-described “referenced customer buy/sell pattern time-series data” from among a large number of rules generated by combining one or a plurality of the above-described determination material items. For example, as the above-described rule, a rule in which “a full-year ordinary income year over year is equal to or more than 5%”, a rule in which “a full-year ordinary income year over year is equal to or more than 5%, and a type of industry is a service industry”, and the like are exemplified, but the present example embodiment is not limited thereto.

### “Configuration of Information Providing Server”

Next, a configuration of the information providing server is described. As described above, the information providing server is an apparatus that transmits predetermined information to a customer terminal according to a customer request.

### <Hardware Configuration>

One example of a hardware configuration of the information providing server is described. FIG. 2 is a diagram illustrating a hardware configuration example of the information providing server. Each functional unit included by the information providing server is achieved by any combination of hardware and software mainly including a central processing unit (CPU) of any computer, a memory, a program loaded in a memory, a storage unit (capable of storing, in addition to a program stored in advance at a shipping stage of an apparatus, a program downloaded from a storage medium such as a compact disc (CD), a server on the Internet, and the like) such as a hard disk storing the program, and an interface for network connection. Further, it is understood by a person skilled in the art that there are various modification examples as a method and an apparatus for achieving the configuration.

As illustrated in FIG. 2, the information providing server includes the processor 1A, the memory 2A, the input/output interface 3A, the peripheral circuit 4A, and the bus 5A. The peripheral circuit 4A includes various modules. The information providing server may not include the peripheral circuit 4A. Note that, the information providing server may be constituted of a plurality of apparatuses that are physically and/or logically separated, or may be constituted of one apparatus that is physically and logically integrated. In the former case, each of the plurality of apparatuses constituting the information providing server can include the above-described hardware configuration.

### <Functional Configuration>

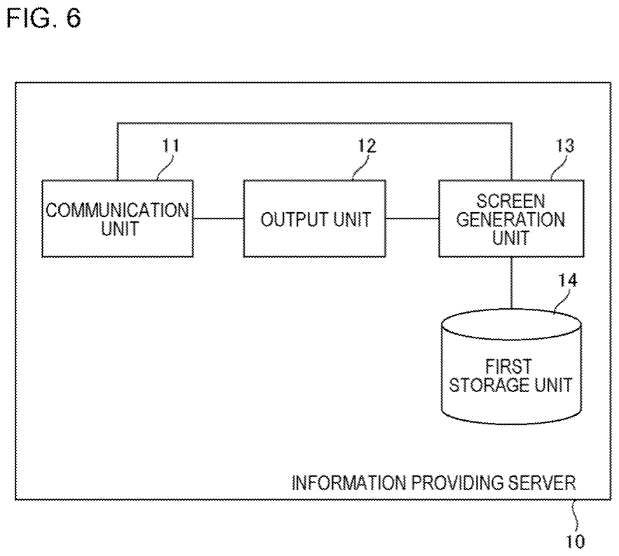

A functional configuration of the information providing server is described. FIG. 6 illustrates one example of a functional block diagram of an information providing server 10. As illustrated in FIG. 6, the information providing server 10 includes a communication unit 11, an output unit 12, a screen generation unit 13, and a first storage unit 14.

The communication unit 11 communicates with a customer terminal via a communication network such as the Internet. The customer terminal is a smartphone, a mobile phone, a tablet terminal, a personal computer, a smartwatch, and the like, but the present example embodiment is not limited thereto.

The first storage unit 14 stores a computation result of the computation unit 22. The screen generation unit 13 generates a screen including predetermined information by using data stored in the first storage unit 14 according to a customer request. The output unit 12 transmits (outputs) the screen generated by the screen generation unit 13 to a customer terminal via the communication unit 11. Consequently, the screen is displayed on the customer terminal. Transmission and reception of the screen is achieved, for example, via a Web page or an application.

FIG. 1 illustrates one example of a screen displayed on a customer terminal. FIG. 1 illustrates one example of a screen, in a case where an investment product is a stock.
(1) in FIG. 1 displays a name of a stock specified by a customer, a current stock price, a stock price change compared to a previous day, the number of shares held by the customer, a total valuation, and a total valuation profit and loss.
(2) in FIG. 1 displays a user interface (IF) component for allowing a customer to select a desired stock from among stocks buying and selling in the past.
(3) in FIG. 1 displays a past transaction history on a stock specified by the customer.
(4) in FIG. 1 displays, side by side, a price chart ((4-1) in FIG. 1) indicating a time-series change in price of a stock (investment product) specified by a customer, and referenced customer buy/sell pattern time-series data ((4-2) in FIG. 1) indicating, in a time-series manner, a buy/sell pattern of the stock of a plurality of referenced customers. A graph indication illustrated in (4-2) in FIG. 1 is achieved based on data computed by the data processing apparatus 20. In the example illustrated in FIG. 1, a price chart, and referenced customer buy/sell pattern time-series data are displayed in the same time-series manner. Specifically, a period to be displayed, a scale unit, a scale interval, a value of each scale, and the like coincide with each other. Further, the price chart and the referenced customer buy/sell pattern time-series data are displayed side by side in a vertical direction in such a way that pieces of data of the same date and time are aligned in the vertical direction.

Note that, in (4-2) in FIG. 1, a UI component with which “sell” and “buy” are selectable is displayed. Further, in (4-2) in FIG. 1, “buy” is selected, and referenced customer buy/sell pattern time-series data indicating, in a time-series manner, a buying pattern of a plurality of referenced customers are displayed. When “sell” is selected, a content of a graph in (4-2) in FIG. 1 is switched to referenced customer buy/sell pattern time-series data indicating, in a time-series manner, a selling pattern of the plurality of referenced customers. In this way, referenced customer buy/sell pattern time-series data indicating, in a time-series manner, a buying pattern of the plurality of referenced customers, and referenced customer buy/sell pattern time-series data indicating, in a time-series manner, a selling pattern of the plurality of referenced customers are displayed separately.

(5) in FIG. 1 illustrates a determination material item being presumed to be a cause of a buying pattern of a referenced customer at a timing specified by a customer, and a state value thereof. Display illustrated in (5) in FIG. 1 is achieved based on data computed by the data processing apparatus 20.

In FIG. 1, Jun. 3, 2019 is specified. For example, it may be configured in such a way that the above-described timing is specified by an operation of selecting one bar graph on a graph in (4-2) in FIG. 1.

(5) in FIG. 1 displays, in pairs, a rule that well contributes to regression of “referenced customer buy/sell pattern time-series data” specified from among a large number of rules, and a degree of contribution indicating a degree by which each rule contributes to regression. In FIG. 1, three rules, and a degree of contribution of each rule are displayed. It is indicated that the larger the degree of contribution, the larger the degree by which each rule contributes to regression of referenced customer buy/sell pattern time-series data.

Note that, in FIG. 1, three rules are displayed, but the number of rules to be displayed herein is a design matter. The screen generation unit 13 may include a means for appropriately selecting a rule to be displayed on a screen from among a plurality of rules contributing to regression, from a point of view of visibility.

For example, the screen generation unit 13 may select a rule to be displayed on a screen, based on a condition of “selecting a predetermined number of rules from among rules having a large degree of contribution”.

In addition, the screen generation unit 13 may include a means configured in such a way that a rule whose content is similar is not repeatedly selected. For example, the screen generation unit 13 may select a rule to be displayed on a screen, based on a condition that “a rule in which some or all of determination material items coincide with each other is not repeatedly selected”. A rule in which some or all of determination material items coincide with each other is, for example, a rule in which “a full-year ordinary income year over year is equal to or more than 5%”, a rule in which “a full-year ordinary income year over year is equal to or more than 10%”, and the like. Both of these two rules are rules in which a determination material item is “a full-year ordinary history year over year”, and completely coincide with each other.

In addition, the screen generation unit 13 may select a rule to which a comparative customer conceivably does not pay attention from among a plurality of rules contributed to regression of referenced customer buy/sell pattern time-series data.

In a case of the example, the computation unit 22 of the data processing apparatus 20 generates comparative customer buy/sell pattern time-series data by a method similar to a generation method of referenced customer buy/sell pattern time-series data. While, in generation of referenced customer buy/sell pattern time-series data, past investment product transaction data of a referenced customer is utilized, in generation of comparative customer buy/sell pattern time-series data, past investment product transaction data of a comparative customer is utilized.

Further, the computation unit 22 of the data processing apparatus 20 presumes a cause of a buy/sell pattern indicated by comparative customer buy/sell pattern time-series data at each timing by a method similar to that of processing of presuming a cause of a buy/sell pattern indicated by referenced customer buy/sell pattern time-series data at each timing.

Further, the screen generation unit 13 selects a rule that is not included in a plurality of rules contributed to regression of comparative customer buy/sell pattern time-series data from among a plurality of rules contributed to regression of referenced customer buy/sell pattern time-series data.

### Advantageous Effect

In the information providing server 10 and the data processing apparatus 20 according to the present example embodiment, as illustrated in (4) in FIG. 1, it is possible to provide a customer with a screen on which data ((4-1) in FIG. 1) indicating a time-series change in price of an investment product, and data ((4-2) in FIG. 1) indicating, in a time-series manner, a buy/sell pattern of a referenced customer whose buying and selling timing is helpful are displayed side by side. The screen allows a customer to learn a relationship between a change in price of an investment product, and a buy/sell pattern of a referenced customer.

Further, according to the information providing server 10 and the data processing apparatus 20, as illustrated in (5) in FIG. 1, it is possible to provide a customer with a screen on which a determination material item being presumed to be a cause of a buy/sell pattern of a referenced customer at a timing specified by the customer, and a state value thereof are displayed. The screen allows a customer to learn based on what determination material, a referenced customer determines a buying and selling timing, and the like.

Further, according to the information providing server 10 and the data processing apparatus 20, it is possible to generate the above-described screen by utilizing not only investment product transaction data of a referenced customer, but also investment product transaction data of a comparative customer whose buying and selling timing is not helpful. By making comparison with a comparative customer, a portion (a buy/sell pattern or a determination material) particularly characteristic to a referenced customer becomes prominent, and it becomes possible to present a customer with the prominent content.

Note that, in the present specification, “acquisition” includes at least one of “acquisition of data stored in another apparatus or a storage medium by an own apparatus (active acquisition)”, based on a user input, or based on a command of a program, for example, requesting or inquiring another apparatus and receiving, accessing to another apparatus or a storage medium and reading, and the like, “input of data to be output from another apparatus to an own apparatus (passive acquisition)”, based on a user input, or based on a command of a program, for example, receiving data to be distributed (or transmitted, push-notified, or the like), and acquiring by selecting from received data or information, and “generating new data by editing data (such as converting into a text, rearranging data, extracting a part of pieces of data, and changing a file format) and the like, and acquiring the new data”.

A part or all of the above-described example embodiment may also be described as the following supplementary notes, but is not limited to the following.
1. An information providing server including
   an output unit that outputs a screen on which referenced customer buy/sell pattern time-series data indicating, in a time-series manner, a buy/sell pattern, computed for each stock, of a plurality of referenced customers satisfying a reference standard, based on past investment product transaction data of the plurality of referenced customers, and a price chart indicating a time-series change in price of an investment product are displayed side by side.
2. The information providing server according to supplementary note 1, wherein
   the output unit outputs a screen on which
      the referenced customer buy/sell pattern time-series data indicating, in a time-series manner, a buying pattern of the plurality of referenced customers, and
      the referenced customer buy/sell pattern time-series data indicating, in a time-series manner, a selling pattern of the plurality of referenced customers are displayed separately.
3. The information providing server according to supplementary note 1 or 2, wherein
   the reference standard is defined by using a valuation profit and loss within a reference period.
4. The information providing server according to supplementary note 3, wherein
   the reference standard is defined by further using at least one of a number of buy/sell per day within a reference period, a total number of buy/sell within a reference period, and a number of stocks buying and selling within a reference period.
5. The information providing server according to any one of supplementary notes 1 to 4, wherein
   the referenced customer buy/sell pattern time-series data are computed based on, in addition to past investment product transaction data of the plurality of referenced customers, past investment product transaction data of a plurality of comparative customers satisfying a comparative standard.
6. The information providing server according to any one of supplementary notes 1 to 5, wherein
   the output unit outputs a screen indicating, based on past investment product transaction data of the plurality of referenced customers, and a past state value of each of a plurality of determination material items, the determination material item being presumed to be a cause of a buy/sell pattern indicated by the referenced customer buy/sell pattern time-series data at each timing, and the state value.
7. The information providing server according to any one of supplementary notes 1 to 6, wherein
   the output unit outputs the screen on which the referenced customer buy/sell pattern time-series data, and the price chart are displayed in a same time-series manner.
8. An information providing method including,
   by a computer,
   outputting a screen on which referenced customer buy/sell pattern time-series data indicating, in a time-series manner, a buy/sell pattern, computed for each stock, of a plurality of referenced customers satisfying a reference standard, based on past investment product transaction data of the plurality of referenced customers, and a price chart indicating a time-series change in price of an investment product are displayed side by side.
9. A program causing a computer to function as
   an output unit that outputs a screen on which referenced customer buy/sell pattern time-series data indicating, in a time-series manner, a buy/sell pattern, computed for each stock, of a plurality of referenced customers satisfying a reference standard, based on past investment product transaction data of the plurality of referenced customers, and a price chart indicating a time-series change in price of an investment product are displayed side by side.
10. A data processing apparatus including:
   a determination unit that determines a plurality of referenced customers satisfying a reference standard, from among a plurality of customers; and
   a computation unit that computes referenced customer buy/sell pattern time-series data indicating, in a time-series manner, a buy/sell pattern of the plurality of referenced customers for each stock, based on past investment product transaction data of the plurality of referenced customers.
11. The data processing apparatus according to supplementary note 10, wherein
   the determination unit further determines a plurality of comparative customers satisfying a comparative standard, from among the plurality of customers, and
   the computation unit computes the referenced customer buy/sell pattern time-series data, based on past investment product transaction data of the plurality of referenced customers, and past investment product transaction data of the plurality of comparative customers.

This application is based upon and claims the benefit of priority from Japanese patent application No. 2021-024931, filed on Feb. 19, 2021, the disclosure of which is incorporated herein in its entirety by reference.

### REFERENCE SIGNS LIST

10 Information providing server
11 Communication unit
12 Output unit
13 Screen generation unit
14 First storage unit
15 Data processing apparatus
21 Determination unit
22 Computation unit
23 Second storage unit
1A Processor
2A Memory
3A Input/output I/F
4A Peripheral circuit
5A Bus

What is claimed is:

1. An information providing server comprising
at least one memory configured to store one or more instructions; and
at least one processor configured to execute the one or more instructions to:
output a screen on which referenced customer buy/sell pattern time-series data indicating, in a time-series manner, a buy/sell pattern, computed for each stock, of a plurality of referenced customers satisfying a reference standard, based on past investment product transaction data of the plurality of referenced customers, and a price chart indicating a time-series change in price of an investment product are displayed side by side.

2. The information providing server according to claim 1, wherein
the processor is further configured to execute the one or more instructions to output a screen on which
the referenced customer buy/sell pattern time-series data indicating, in a time-series manner, a buying pattern of the plurality of referenced customers, and
the referenced customer buy/sell pattern time-series data indicating, in a time-series manner, a selling pattern of the plurality of referenced customers are displayed separately.

3. The information providing server according to claim 1, wherein
the reference standard is defined by using a valuation profit and loss within a reference period.

4. The information providing server according to claim 3, wherein
the reference standard is defined by further using at least one of a number of buy/sell per day within a reference period, a total number of buy/sell within a reference period, and a number of stocks buying and selling within a reference period.

5. The information providing server according to claim 1, wherein
the referenced customer buy/sell pattern time-series data are computed based on, in addition to past investment product transaction data of the plurality of referenced customers, past investment product transaction data of a plurality of comparative customers satisfying a comparative standard.

6. The information providing server according to claim 1, wherein
the processor is further configured to execute the one or more instructions to output a screen indicating, based on past investment product transaction data of the plurality of referenced customers, and a past state value of each of a plurality of determination material items, the determination material item being presumed to be a cause of a buy/sell pattern indicated by the referenced customer buy/sell pattern time-series data at each timing, and the state value.

7. An information providing method comprising,
by a computer,
outputting a screen on which referenced customer buy/sell pattern time-series data indicating, in a time-series manner, a buy/sell pattern, computed for each stock, of a plurality of referenced customers satisfying a reference standard, based on past investment product transaction data of the plurality of referenced customers, and a price chart indicating a time-series change in price of an investment product are displayed side by side.

8. A non-transitory storage medium storing a program causing a computer to output a screen on which referenced customer buy/sell pattern time-series data indicating, in a time-series manner, a buy/sell pattern, computed for each stock, of a plurality of referenced customers satisfying a reference standard, based on past investment product transaction data of the plurality of referenced customers, and a price chart indicating a time-series change in price of an investment product are displayed side by side.

9. A data processing apparatus comprising:
at least one memory configured to store one or more instructions; and
at least one processor configured to execute the one or more instructions to:
determine a plurality of referenced customers satisfying a reference standard, from among a plurality of customers; and
compute referenced customer buy/sell pattern time-series data indicating, in a time-series manner, a buy/sell pattern of the plurality of referenced customers for each stock, based on past investment product transaction data of the plurality of referenced customers.
